(19) United States
(12) Patent Application Publication
(10) Pub. No.: US 2006/0256146 A1
(43) Pub. Date: Nov. 16, 2006

(54) Information recording and reproducing apparatus, information printing method, and optical information recording medium

(75) Inventor: Yoshihisa Usami, Fuji-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/412,998

(22) Filed: Apr. 28, 2006

(30) Foreign Application Priority Data
May 10, 2005 (JP) 2005-137696

(51) Int. Cl. B41J 3/00

(52) U.S. Cl. 347/2

(57) ABSTRACT

An information recording and reproducing apparatus has a recorder and reproducer and a printer. The printer has a print head disposed in confronting relation to the printable surface of the optical information recording medium which is being mounted on the rotation driver, a head moving mechanism for moving the print head radially of the optical information recording medium along a plane substantially parallel to the printable surface of the optical information recording medium, a video memory for temporarily storing the print information, and a controller for controlling a readout rate at which the print information is to be read from the video memory based on at least rotational speed information from the rotation driver and positional information of the print head.

### BACKGROUND OF THE INVENTION

1. Field of the Invention

The present invention relates to an information recording and reproducing apparatus for recording and/or reproducing information in and/or from an optical information recording medium with a laser beam, for example.

The present invention also relates to an information printing method for printing print information on a printable surface of an optical information recording medium with information recorded thereon.

The present invention further relates to an optical information recording medium having information recorded therein and print information printed on a surface thereof.

The present invention is preferably applicable to a CR-R, a CD+R, a CD−RW, a CD+RW, a DVD−R, a DVD+R, a DVD−RW, a DVD+RW, a DVD-RAM, or the like.

2. Description of the Related Art

There has recently been known a process of managing an optical information recording medium capable of writing information therein, e.g., a CD−R, a DVD−R, or the like, after information has been recorded therein. According to the process, after information has been recorded from one surface of the optical information recording medium into an information recording surface therein, comments and images of the recorded information are displayed for management by handwriting or by applying stickers on the other surface of the optical information recording medium, i.e., a printable surface (label surface).

The user can handwrite accurate information or apply a sticker bearing accurate information for a single optical information recording medium after the optical information recording medium has been removed from an information recording and reproducing apparatus because the user usually can remember the information about the single optical information recording medium. If, however, the user needs to apply handwritten information to a plurality of optical information recording mediums, then the user tends to fail to accurately recognize all the information that has been recorded in the optical information recording mediums. Therefore, the user has to load each of the optical information recording mediums again into the information recording and reproducing apparatus to confirm the recorded information, thereby making the process time-consuming.

According to a conventional process proposed to circumvent the above difficulty, an information recording and reproducing apparatus incorporates a printing means in addition to an information recording and reproducing means. After the information recording and reproducing means has recorded information in an optical information recording medium, the printing means prints a label or the like on the optical information recording medium. For details, reference should be made to Japanese Laid-Open Patent Publication No. 5-238005, Japanese Laid-Open Patent Publication No. 2000-228036, and, Japanese Laid-Open Patent Publication No. 2004-110994).

The technologies disclosed in Japanese Laid-Open Patent Publication No. 5-238005 and Japanese Laid-Open Patent Publication No. 2004-110994 employ an ink jet printer for printing information on an optical information recording medium while the optical information recording medium is rotating at a high speed. The speed at which ink is ejected toward the optical information recording medium and the position where ink droplets are applied to the optical information recording medium need to be calculated depending on the rotational speed of the optical information recording medium. The information to be printed has to be deformed depending on the calculated ink ejection speed and ink droplet impact position. Therefore, the time required for information processing is considerably long. Another problem is that since the ink is ejected toward the optical information recording medium which is in rotation, the ink tends to flow in a radial pattern, tending to contaminate surrounding areas.

Japanese Laid-Open Patent Publication No. 2000-228036 discloses a system having an information recorder for recording information on an optical information recording medium, a printer for printing information on a surface of the optical information recording medium after the information has been recorded thereon, and a retriever for retrieving the printed optical information recording medium. Since the information recorder, the printer, and the retriever are disposed independently of each other, the system is relatively large in size. Though the large-size system appears to pose no essential problem if it is limited to business use, the system suffers from drawbacks such as a large installation space if used by general users and consumers.

### SUMMARY OF THE INVENTION

It is therefore an object of the present invention to provide an information recording and reproducing apparatus, an information printing method, and an optical information recording medium which are capable of printing accurate information (image information, character information, etc.) about information recorded in an optical information recording medium while the optical information recording medium is being loaded in an information recording and reproducing apparatus, easily without contaminating surrounding areas, and which facilitate the information recording by general users of information in the optical information recording medium.

According to a first aspect of the present invention, there is provided an apparatus for recording and reproducing information, comprising a recorder and reproducer for recording information in and/or reproducing information from an optical information recording medium mounted on a rotation driver, and a printer for printing print information including image and character data on a printable surface of the optical information recording medium which is being mounted on the rotation driver, wherein the printer comprises a print head disposed in confronting relation to the printable surface of the optical information recording medium which is being mounted on the rotation driver, a moving mechanism for moving the print head radially of the optical information recording medium along a plane substantially parallel to the printable surface of the optical information recording medium, a storage means for temporarily storing the print information, and a controller for controlling a readout rate at which the print information is to be read from the storage means based on at least rotational speed information from the rotation driver and positional information of the print head.

According to the above apparatus, print information (image information, character information, etc) with respect to information recorded in the optical information recording medium which is being loaded in the apparatus can easily and accurately be printed without contaminating surrounding areas, and information recording by general users of information in the optical information recording medium is facilitated.

According to the first aspect of the present invention, the recorder and reproducer may comprise a recording head disposed in confronting relation to a surface of the optical information recording medium which is opposite to the printable surface, for recording information in the optical information recording medium, and a recording head moving mechanism for moving the recording head radially of the optical information recording medium.

According to the first aspect of the present invention, the print head may have a nozzle region including a plurality of nozzles, the nozzle region having a longer side inclined to a moving direction of the print head by an angle of up to 45°, preferably up to 30°, or more preferably up to 15°.

When the optical information recording medium is held at rest, the controller may control the rotation driver to rotate the optical information recording medium at a rotational speed suitable for printing the print information thereon, and then the controller may control the print head to print the print information on the optical information recording medium while the optical information recording medium is rotating at the rotational speed. Alternatively, when the recorder and reproducer records information in and/or reproduces information from the optical information recording medium, the controller may control the print head to print the print information on the optical information recording medium while the optical information recording medium is rotating at a rotational speed suitable for printing the print information thereon.

The apparatus may further comprises a print editor for editing the print information, and the print editor may supply information with respect to either information to be recorded in the optical information recording medium or information recorded in the optical information recording medium as the print information to the printer.

The print editor may comprise a means for employing part of either the information to be recorded in the optical information recording medium or the information recorded in the optical information recording medium as the print information.

Alternatively, the print editor may comprise a means for acquiring the information with respect to either the information to be recorded in the optical information recording medium or the information recorded in the optical information recording medium through a network and employing the acquired information as the print information.

Further alternatively, the print editor may comprise a means for employing character information entered through an input device with respect to either the information to be recorded in the optical information recording medium or the information recorded in the optical information recording medium as the print information.

According to a second aspect of the present invention, there is also provide a method of printing information in an apparatus for recording information in and/or reproducing information from an optical information recording medium mounted on a rotation driver, for printing print information including image and character data on a printable surface of the optical information recording medium which is being mounted on the rotation driver, the method comprising the steps of temporarily holding the print information in a storage means, placing a print head in confronting relation to the printable surface of the optical information recording medium which is being mounted on the rotation driver, moving the print head radially of the optical information recording medium along a plane substantially parallel to the printable surface of the optical information recording medium, printing the print information on the printable surface of the optical information recording medium while controlling a readout rate at which the print information is to be read from the storage means based on at least rotational speed information from the rotation driver and positional information of the print head.

According to the above method, print information (image information, character information, etc) with respect to information recorded in the optical information recording medium which is being loaded in the apparatus can easily and accurately be printed without contaminating surrounding areas, and the information recording by general users of information in the optical information recording medium is facilitated.

According to the second aspect of the present invention, the print head may have a nozzle region including a plurality of nozzles, the nozzle region having a longer side inclined to a moving direction of the print head by an angle of up to 45°, preferably up to 30°, or more preferably up to 15°.

When the optical information recording medium is held at rest, the rotation driver may be controlled to rotate the optical information recording medium at a rotational speed suitable for printing the print information thereon, and the print information may be printed on the optical information recording medium while the optical information recording medium is rotating at the rotational speed.

When information is recorded in and/or reproduced from the optical information recording medium by the recorder and reproducer, the print head may be controlled to print the print information on the optical information recording medium while the optical information recording medium is rotating at a rotational speed suitable for printing the print information thereon.

Information with respect to either information to be recorded in the optical information recording medium or information recorded in the optical information recording medium may be printed as the print information on the printable surface of the optical information recording medium.

Alternatively, part of either the information to be recorded in the optical information recording medium or the information recorded in the optical information recording medium may be printed as the print information on the printable surface of the optical information recording medium.

Further alternatively, the information to be recorded in the optical information recording medium or the information recorded in the optical information recording medium may be acquired through a network and printed as the print information on the printable surface of the optical information recording medium.

Character information-entered through an input device with respect to the information to be recorded in the optical information recording medium or the information recorded in the optical information recording medium may be printed as the print information on the printable surface of the optical information recording medium.

According to a third aspect of the present invention, there is further provided an optical information recording medium having information recorded therein and print information printed thereon by the method described above. Consequently, one or more optical information recording mediums can easily and accurately be managed based on the printed information thereon, and the information recording by general users of information in optical information recording mediums is facilitated.

As described above, with the apparatus for recording and reproducing information, the method of printing information, and the optical information recording medium according to the present invention, print information (image information, character information, etc) with respect to information recorded in the optical information recording medium which is being loaded in the apparatus can easily and accurately be printed without contaminating surrounding areas, and the information recording by general users of information in the optical information recording medium is facilitated.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of an information recording and reproducing apparatus according to an embodiment of the present invention;

FIG. 2 is a fragmentary plan view showing a preferred setup of a print head;

FIG. 3 is a fragmentary elevational view showing the preferred setup of the print head;

FIG. 4 is a diagram showing the recording area of a video memory;

FIG. 5 is a block diagram of a print editor;

FIG. 6 is a diagram of details of an information table;

FIG. 7 is a block diagram showing a processing sequence of an image data registering unit;

FIG. 8 is a block diagram showing another processing sequence of an image data registering unit;

FIG. 9 is a block diagram showing still another processing sequence of an image data registering unit;

FIG. 10A is a diagram showing image data displayed as thumbnail images on a monitor screen;

FIG. 10B is a diagram showing the image data recorded in the recording area of the video memory;

FIG. 11A is a diagram showing image data as they are moved, enlarged, and reduced on the monitor screen;

FIG. 11B is a diagram showing the image data recorded in the recording area of the video memory;

FIG. 12A is a diagram showing a text entry frame and a cursor displayed on the monitor screen;

FIG. 12B is a diagram showing the image data recorded in the recording area of the video memory;

FIG. 13A is a diagram showing character data entered in the test entry frame;

FIG. 13B is a diagram showing the image data and the character data recorded in the recording area of the video memory;

FIG. 14A is a diagram showing the character data as they are moved and reduced on the monitor screen;

FIG. 14B is a diagram showing the image data and the character data recorded in the recording area of the video memory;

FIG. 15 is a flowchart of a processing sequence of a printer;

FIGS. 16A and 16B are diagrams showing a rearrangement of data from a first video memory to a second video memory; and

FIG. 17 is a perspective view of an optical disk having a printable surface on which image data and character data edited by the user are printed.

### DESCRIPTION OF THE PREFERRED EMBODIMENTS

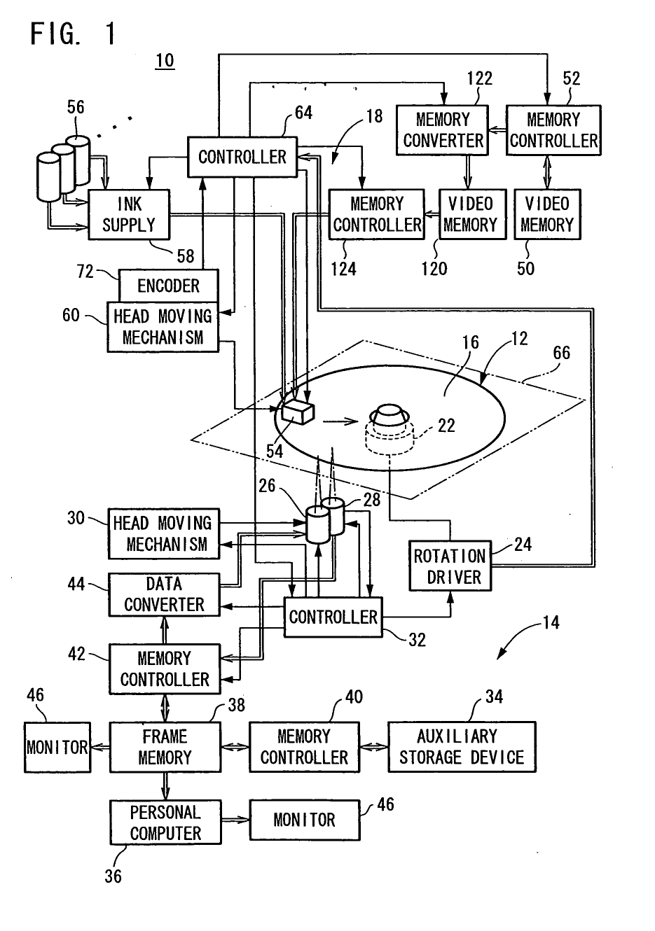

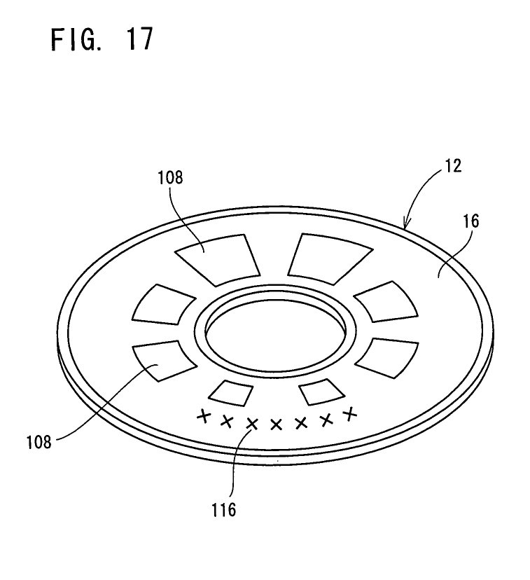

An information recording and reproducing apparatus, an information printing method, and an optical information recording medium (optical disk) according to the present invention, as they are used on or applied to an optical information recording medium capable of recording and reproducing information with a laser beam, for example, will be described below with reference to FIGS. 1 through 17.

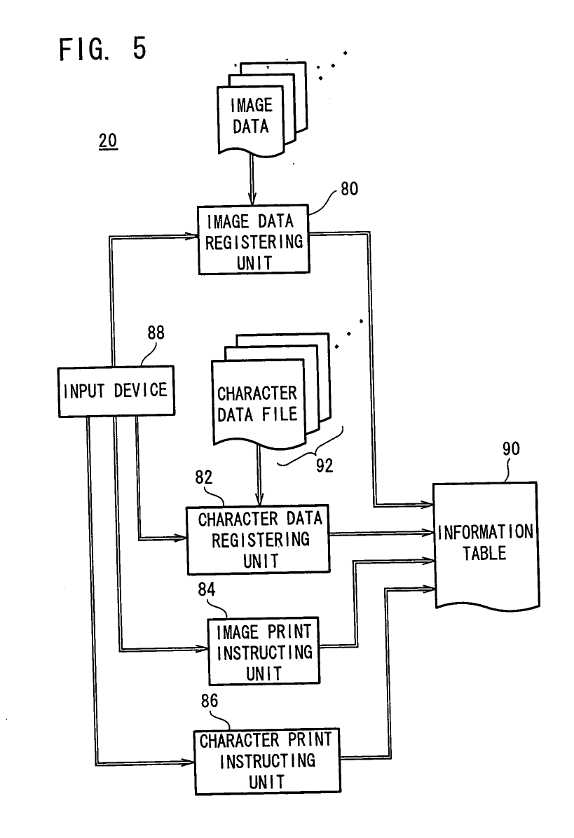

As shown in FIG. 1, an information recording and reproducing apparatus 10 according to an embodiment of the present invention has a recorder and reproducer 14 for recording information and/or reproducing information in and/or from an optical disk 12, a printer 18 for printing print information such as of images, characters, etc. on a printable surface 16 of the optical disk 12, and a print editor 20 (see FIG. 5) for editing the print information. The print information includes titles, recording dates, recording times, image quality (information such as double speed or the like), image sources such as broadcast channels or the like, thumbnail images of typical images, etc. of the information recorded in the optical disk 12. Images that can be printed include images such as photos and pictures, symbols, bar codes, etc., and all images that can visually be perceived with eyes, a magnifying lens, a microscope, etc. Therefore, the images that can be printed include patterns having a general size of 10 μm or greater. The print editor 20 should preferably be software-implemented to allow the user to confirm details of information recorded in the optical disk 12, select some of the recorded information as print information, and enter comments.

The recorder and reproducer 14 has a rotation driver 24 having a spindle motor 22 for rotating the optical disk 12 at CLV (Constant Linear Velocity) or CAV (Constant Angular Velocity), a recording head 26 disposed in confronting relation to a surface (opposite to the printable surface 16) of the optical disk 12 for recording information in the optical disk 12, a reproducing head 28 disposed in confronting relation to the surface of the optical disk 12 for reproducing information (including positional information) from the optical disk 12, a recording and reproducing head moving mechanism 30 for moving the recording head 26 and the reproducing head 28 radially of the optical disk 12, and a first controller 32 for controlling the rotation driver 24, the recording head 26, the reproducing head 28, and the recording and reproducing head moving mechanism 30.

Information that may be recorded in the optical disk 12 includes program information document information, and image information (still image information and moving image information) which are downloaded through a network, for example, and image information (still image information and moving image information) which is recorded in recording mediums (e.g., video tapes, etc.). This information is tentatively recorded in an auxiliary storage device 34. The auxiliary storage device 34 may be a hard disk if the information recording and reproducing apparatus 10 incorporates such a hard disk, or may be a hard disk or the like incorporated in a personal computer 36 that is connected to the information recording and reproducing apparatus 10. The recorder and reproducer 14 has, in addition to the above components, a first memory controller 40 for transferring data between the auxiliary storage device 34 and a frame memory 38, and a second memory controller 42 for transferring data between the frame memory 38 and the recording and reproducing heads 26, 28.

It is assumed in the description which follows that the information recording and reproducing apparatus 10 mainly records image information (still image information and moving image information) in the optical disk 12. However, the information recording and reproducing apparatus 10 may also be used to record program information and document information in the optical disk 12.

The image information recorded in the auxiliary storage device 34 is read successively frame by frame (one frame has a period of 1/60 second) by the first memory controller 40, and written into the frame memory 38. Each frame of image information stored in the frame memory 38 is read by the second memory controller 42, and output to the recording head 26. The image information that is read by the second memory controller 42 is supplied to the recording head 26 after it is converted by a data converter 44 into a data form which matches the recording format of the optical disk 12. If it takes a long period of time to supply data to the recording head 26, then the frame memory 38 may be of a dual memory configuration having two frame memories for alternately writing and reading data.

The reproducing head 28 applies a reproducing laser beam to the optical disk 12 while it is rotating at CLV or CAV. The reproducing head 28 detects a position on the optical disk 12 where image information is to be recorded (recording position), i.e., operates in a seek mode, based on an address signal represented by a laser beam which is reflected from the optical disk 12, e.g., a wobbling pre-groove or an address pre-pit on the optical disk 12.

The recording head 26 modulates a recording laser beam with the supplied data, and applies the modulated recording laser beam to the recording position detected by the reproducing head 28. If the recording head 26 and the reproducing head 28 are combined as one unit, then the recording head 26 starts recording image information at the time the reproducing head 28 detects the recording position. In this manner, the image information is recorded successively frame by frame in the optical disk 12. The recording head 26 may record image information according to a recording process employing an organic dye material, a phase-change recording process, or the like. The recorder and reproducer 14 can record information according to any of these recording processes.

The reproducing head 28 reproduces recorded image data from the optical disk 12, in addition to detecting the recording position as described above.

The reproduced image data are supplied through the second memory controller 42, the frame memory 38, and the first memory controller 40 to the auxiliary storage device 34, and recorded in the auxiliary storage device 34.

If a display monitor 46 is connected to the information recording and reproducing apparatus 10, then the image information recorded in the frame memory 38 is supplied to the display monitor 46, and displayed on the display monitor 46. If a display monitor 46 and the personal computer 36 are connected to the information recording and reproducing apparatus 10, then the image information recorded in the frame memory 38 is supplied to the display monitor 46 and the personal computer 36, and displayed on the display monitor 46 connected to the personal computer 36. Therefore, the image information which is being recorded in the optical disk 12 or reproduced from the optical disk 12 is displayed on the display monitors 46.

It is assumed that the printer 18 is an ink jet printer, for example. The printer 18 has a first video memory 50 for storing print information according to an operating instruction from the user, a third memory controller 52 for writing print information in the first video memory 50 and reading print information successively from the first video memory 50, a print head 54 for printing print information on the printable surface 16 of the optical disk 12 according to an ink jet printing process, a memory converter 122 for converting the print information stored in the first video memory 50 into print information in a sequence depending on the direction in which the print head 54 prints on the optical disk 12 and writing the converted print information in the second video memory 120, a fourth memory controller 124 for reading the print information stored in the second video memory 120 in a sequence of addresses, an ink supply 58 for supplying a plurality of inks 56 to the print head 54, a head moving mechanism 60 for moving the print head 54 in a predetermined direction, i.e., a radial direction of the optical disk 12, and a second controller 64 for controlling the third memory controller 52, the fourth memory controller 124, the memory converter 122, the print head 54, the ink supply 58, and the head moving mechanism 60.

The print head 54 prints print information stored in the second video memory 120 on the printable surface 16 of the optical disk 12 according to the ink jet printing process.

When the recording by the recorder and reproducer 14 of information in the optical disk 12 is finished, the second controller 64 directly or indirectly controls the rotation driver 24 of the recorder and reproducer 14 to rotate the optical disk 12 at CLV or CAV for printing print information thereon.

The second controller 64 also has a function to set a rate of reading data from the second video memory 120 based on the rotational speed of the spindle motor 22 and the positional information of the print head 54, and gives the set rate to the fourth memory controller 124.

The print head 54 is controlled by the head moving mechanism 60 to move radially of the optical disk 12 along a plane 66 substantially parallel to the printable surface 16 of the optical disk 12.

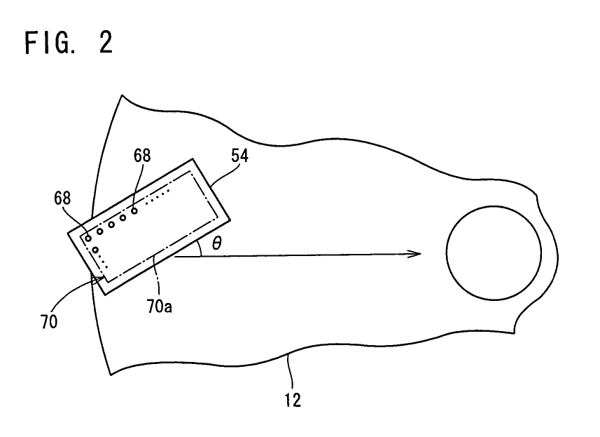

As shown in FIG. 2, the print head 54 has a region (nozzle region) 70 including a matrix of ink jet nozzles 68. The nozzle region 70 is of a rectangular shape having a longer side 70a that is inclined to the moving direction of the print head 54, i.e., the radial direction of the optical disk 12, by an angle θ of 45° or less, preferably 30° or less, or more preferably 15° or less. The smaller the angle θ, the simpler the image processing for printing print information and the higher the printing speed. On the other hand, the angle θ may be 90°. If the angle θ is 90°, then since the printing resolution is higher, making it possible to print images of higher definition. However, the image processing for printing print information becomes more complex, and the printing speed may be lower. Consequently, the angle 0 may be set to different values depending on the specification of the information recording and reproducing apparatus 10.

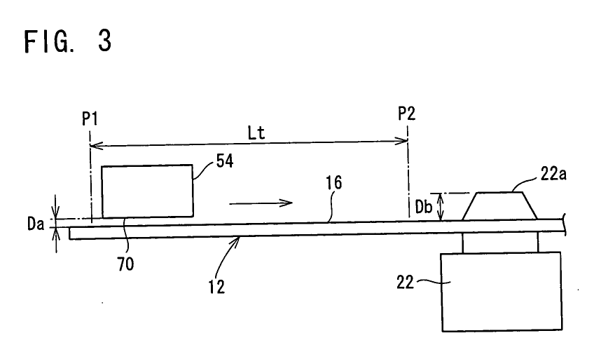

As shown in FIG. 3, the nozzle region 70 of the print head 54 is spaced from the optical disk 12 by a distance Da that is smaller than the distance Db from the printable surface 16 of the optical disk 12 to a tip end 22a of the spindle motor 22. The print head 54 is movable in a radial range Lt extending from a radially outermost position P1 of the printable surface 16 of the optical disk 12 to a radially innermost position P2 thereof where the print head 54 is kept out of contact with the tip end 22a of the spindle motor 22. With these distance and movable range settings, the nozzle region 70 of the print head 54 can be brought as closely to the printable surface 16 of the optical disk 12 as possible. As a result, even while the optical disk 12 is in rotation, the position where the ink arrives at the printable surface 16 is not largely displaced off a target position. The quality of printed data on the printable surface 16 while the optical disk 12 is in rotation is thus prevented from being unduly lowered.

As shown in FIG. 1, an encoder 72 is connected to the head moving mechanism 60. The encoder 72 is electrically connected to the second controller 64 to allow the second controller 64 to electrically recognize the position of the print head 54.

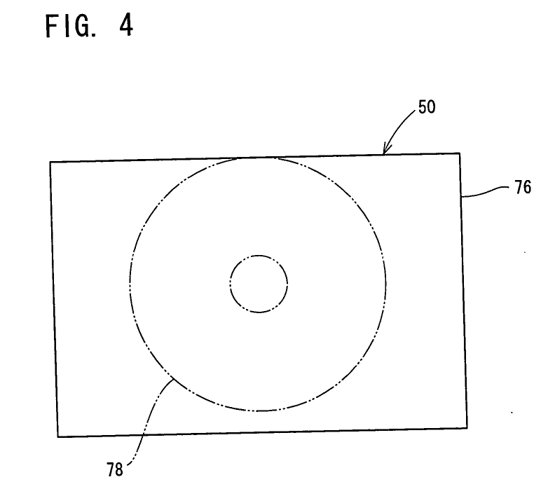

As shown in FIG. 4, the first video memory 50 has a maximum recording area 76 including a doughnut-shaped recording area 78 corresponding to the printable surface 16 of the optical disk 12. The doughnut-shaped recording area 78 is an area that can be printed by the print head 54. Image data and character data that are stored in the doughnut-shaped recording area 78 are printed on the printable surface 16 of the optical disk 12 by the print editor 20 (see FIG. 5).

Though image data and character data may be stored in the first video memory 50 without regard to the doughnut-shaped recording area 78, since the print head 54 is movable only in the area corresponding to the recording area 78, those data stored in the first video memory 50 outside of the recording area 78 are ignored.

Of the maximum recording area 76 of the first video memory 50, an area in which image data and character data are not recorded stores an initial value (e.g., a logic value=“0”) indicative of no printing.

The print editor 20 may be implemented by a software program that is activated and controlled by a CPU incorporated in the information recording and reproducing apparatus 10 or a software program that is activated and controlled by the personal computer 36 connected to the information recording and reproducing apparatus 10. The print editor 20 operates in a multitasking environment so that it can edit information while image information is being recorded in the optical disk 12.

As shown in FIG. 5, the print editor 20 has an image data registering unit 80, a character data registering unit 82, an image print instructing unit 84, and a character print instructing unit 86.

The image data registering unit 80 captures one or more frames of image data from image information to be recorded in the optical disk 12 or other image information in accordance with an image data capturing instruction from an input device 88, and registers an initial storage address of the captured image data, i.e., an initial address of an area of the auxiliary storage device 34 where the captured image data are stored, in an information table 90.

The character data registering unit 82 registers character data entered from the input device 88 in a character data file 92 placed at particular addresses in auxiliary storage device 34, and also registers an initial storage address of the entered character data, i.e., an initial address of an area of the character data file 92 where the entered character data are stored, in the information table 90.

The input device 88 may comprise a keyboard and a coordinate input device (mouse) that are connected to the information recording and reproducing apparatus 10 or a keyboard and a coordinate input device (mouse) that are connected to the personal computer 36 connected to the information recording and reproducing apparatus 10.

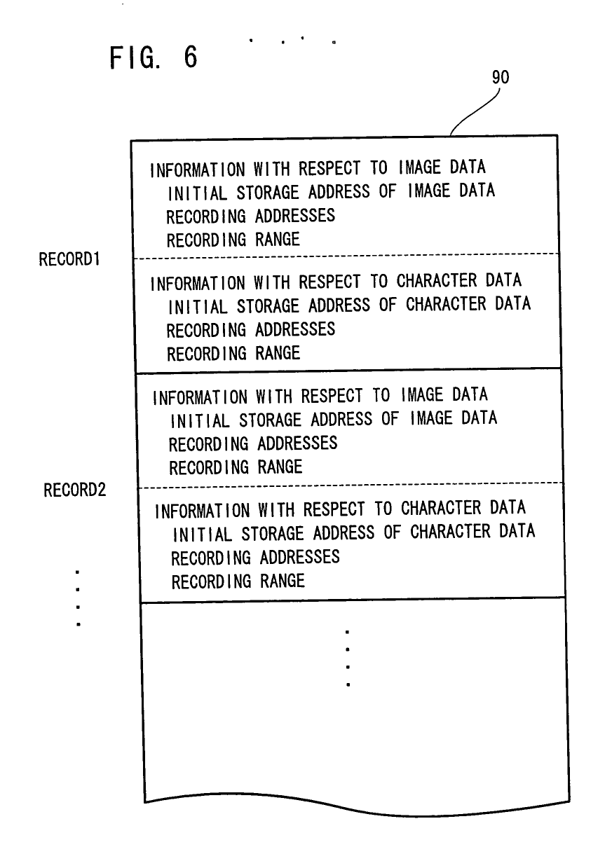

As shown in FIG. 6, the information table 90 comprises a plurality of records each for registering information with respect to captured image data and information with respect to entered character data.

The information with respect to captured image data includes an initial storage address of the image data, recording addresses at which the image data are recorded in the first video memory 50, and a recording range of the image data.

The information with respect to entered character data includes an initial storage address of the character data, recording addresses at which the character data are recorded in the first video memory 50, and a recording range of the character data.

The image print instructing unit 84 serves to indicate the position on printable surface 16 of the optical disk 12 where the image data captured by the image data registering unit 80 are to be printed, and also to indicate whether the image data are to be enlarged or reduced. The image print instructing unit 84 calculates recording addresses at which the image data are to be recorded in the first video memory 50, and a recording range of the image data, based on coordinate data or the like entered through the input device 88, and registers the calculated recording addresses and the calculated recording range in the information table 90.

The character print instructing unit 86 serves to indicate the position on printable surface 16 of the optical disk 12 where the character data registered by the character data registering unit 82 are to be printed, and also to indicate whether the character data are to be enlarged or reduced. The character print instructing unit 86 calculates recording addresses at which the character data are to be recorded in the first video memory 50, and a recording range of the character data, based on coordinate data or the like entered through the input device 88, and registers the calculated recording addresses and the calculated recording range in the information table 90.

The print editor 20 operates according to commands entered through a GUI (Graphical User Interface) from the user.

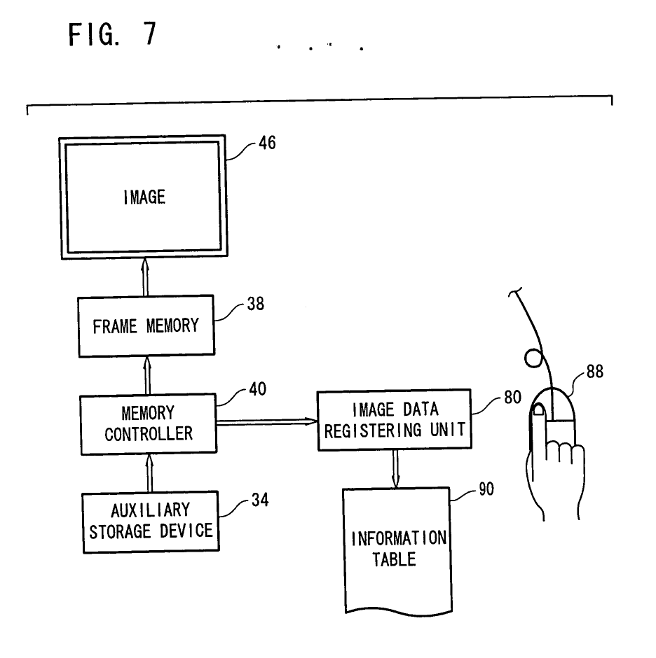

For example, as shown in FIG. 7, if image information stored in the auxiliary storage device 34 is recorded in the optical disk 12 while being displayed on the display monitor 46, then when the user enters a capturing instruction (e.g., by clicking on the left button of the mouse) through the input device 88 at the time a favorite image is displayed, or when the user enters a random capturing instruction, the image data registering unit 80 acquires the initial address of the image data at the time the capturing instruction is entered from the first memory controller 40, and stores the acquired initial address in the information table 90.

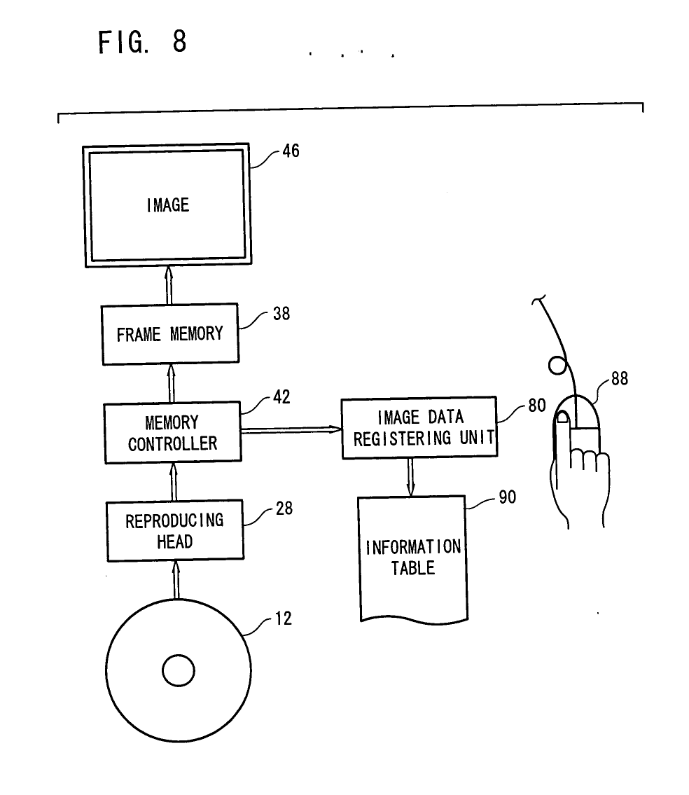

Alternatively, as shown in FIG. 8, if the optical disk 12 with image information already recorded thereon is played back, then when the user enters a capturing instruction (e.g., by clicking on the left button of the mouse) through the input device 88 at the time a favorite image is displayed, or when the user enters a random capturing instruction, the image data registering unit 80 acquires the initial address of the image data at the time the capturing instruction is entered from the second memory controller 42, and stores the acquired initial address in the information table 90.

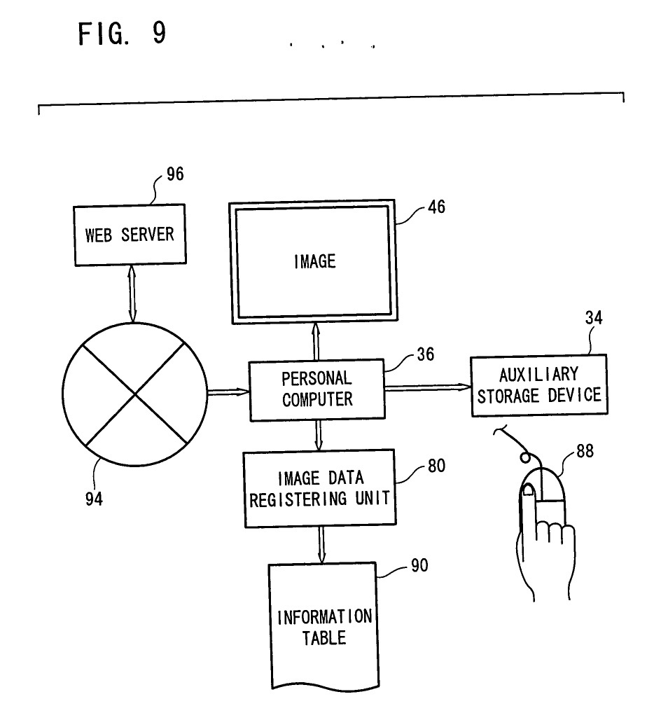

Further alternatively, as shown in FIG. 9, if the user uses the personal computer 36 to display a Web page (including a homepage) on a Web server 96 connected to a network 94, then when the user downloads an image (reference image) related to the image information to be recorded in the optical disk 12 and enters a capturing instruction through the input device 88, the image data registering unit 80 acquires an initial address at which the reference image is recorded from the auxiliary storage device 34 through the personal computer 36, and stores the acquired initial address in the information table 90.

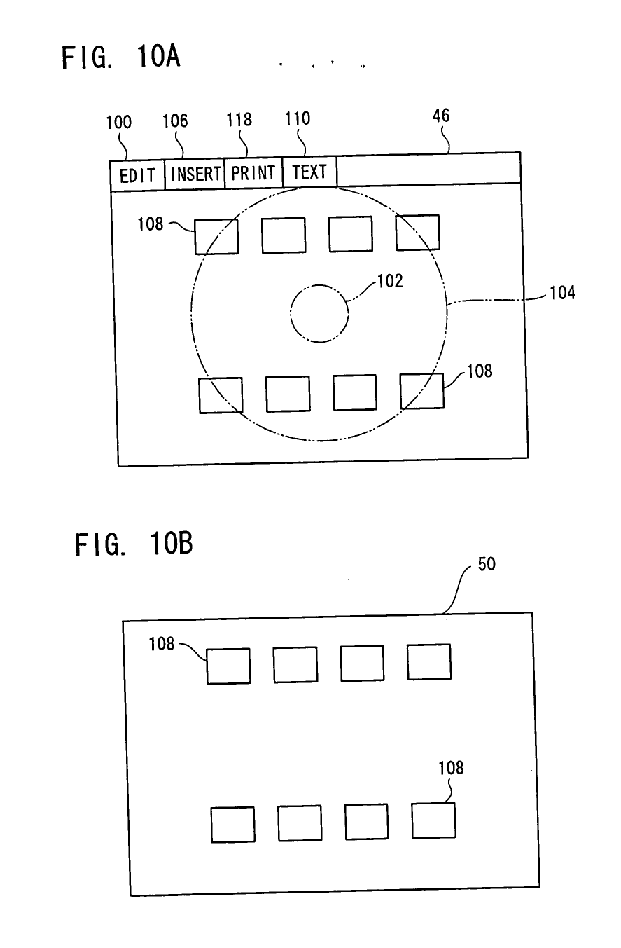

When the capture of the image data is finished, the user selects (e.g., by clicking on the left button of the mouse) a switch or icon representing editing which is displayed on the display monitor 46, for example, as shown in FIG. 10A. The image print instructing unit 84 is now activated to display the data recorded in the first video memory 50 on the display monitor 46. At this time, two circles 102, 104 representing the doughnut-shaped recording area 78 (see FIG. 4) which corresponds to the printable surface 16 of the optical disk 12 is preferably displayed on the display monitor 46. The user can thus recognize at glance which position images and characters are to be printed in for protection against any image and character defects or shortages on the printable surface 16. In addition, the user finds it easy to design a layout of images and characters, resulting in a reduced period of time for editing. This is effective to get rid of the user's prejudice that the editing process is tedious and time-consuming.

Thereafter, the user selects a switch or icon 106 representing image insertion which is displayed on the display monitor 46. Only information with respect to the image data registered in the information table 90 is extracted, and image data 108 are read from registered initial storage addresses. The read image data 108 are stored in the first video memory 50, as shown in FIG. 10B, and are displayed on the display monitor 46, as shown in FIG. 10A. Specifically, as shown in FIG. 10B, the image data 108 that are stored in the first video memory 50 are reduced to such a size that eight image data 108, for example, can be displayed on the display monitor 46. Those eight image data 108 are displayed as thumbnail images on the display monitor 46, as shown in FIG. 10A.

At this time, the image print instructing unit 84 registers recording addresses in the first video memory 50 which correspond to the displayed positions of the image data 108 and a recording range of the image data 108, in the information table 90.

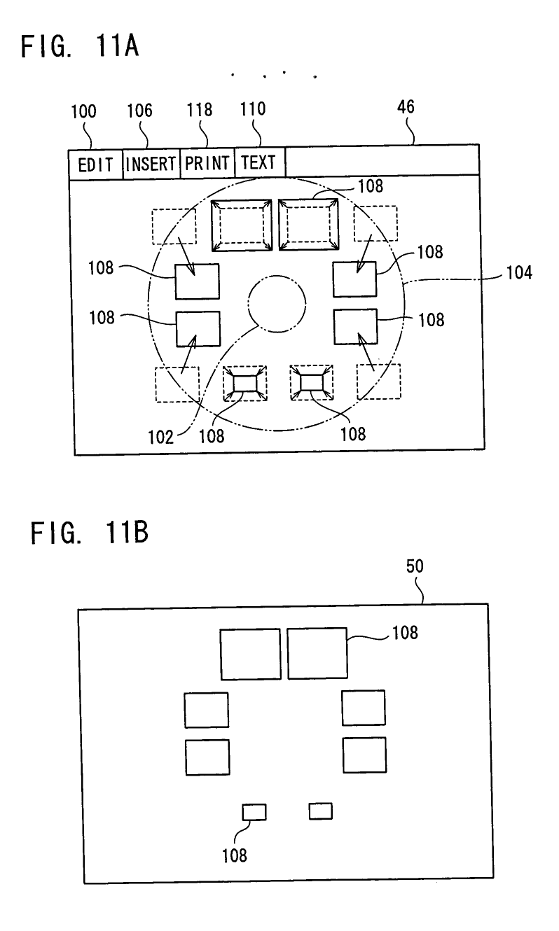

As shown in FIG. 11A, the user uses the input device 88, e.g., drags the mouse, to change the displayed positions of the image data 108 and enlarge and reduce the image data 108 so that the displayed image data 108 are brought into the printable surface 16 of the optical disk 12, i.e., into a doughnut-shaped region defined between the two circles 102, 104. When the displayed positions are changed and the image data are enlarged and reduced, coordinate data from the input device 88 are supplied to the image print instructing unit 84. Based on the supplied coordinate data, the image print instructing unit 84 calculates recording addresses at which the image data 108 are recorded in the first video memory 50 and a recording range of the image data 108, and registers the calculated recording addresses and the calculated recording range in the information table 90, i.e., rewrites the existing recording addresses and the existing recording range in the information table 90, as shown in FIG. 11B.

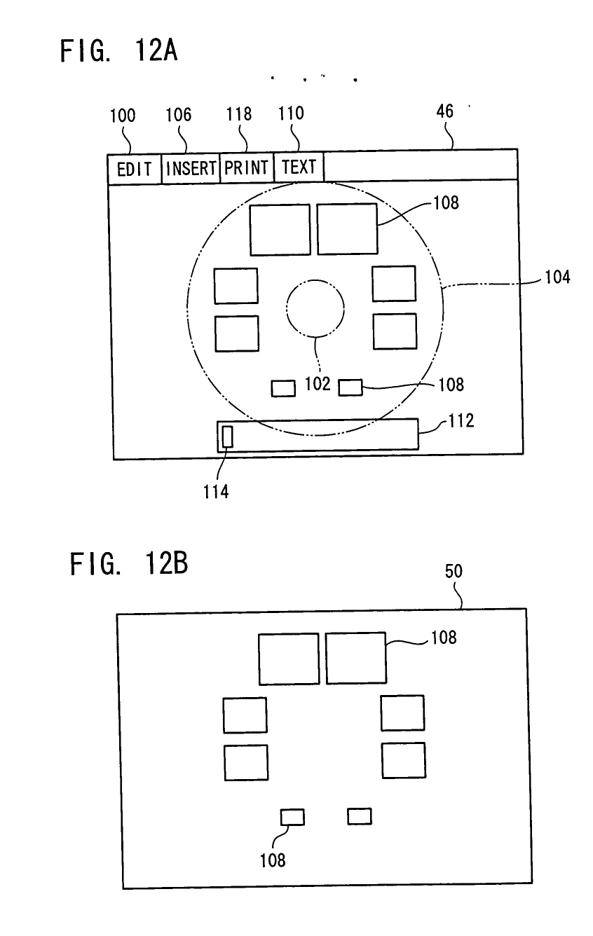

If the user wants to print characters (simple comments or the like) that the user enters, as well as the image data 108, then, as shown in FIG. 12A, the user selects a switch or icon 110 representing entry of text which is displayed on the display monitor 46. The character print instructing unit 86 is now activated to display a text entry frame 112 in a blank area on the display monitor 46, with a cursor 114 displayed in the text entry frame 112. At this time, the character print instructing unit 86 registers recording addresses in the first video memory 50 which correspond to the displayed positions of the text entry frame 112 and a recording range of the text entry frame 112, in the information table 90. The user is now allowed to enter characters into the text entry frame 112. At this stage, no character data are stored in the first video memory 50, as shown in FIG. 12B, i.e., any character data to be printed are not displayed.

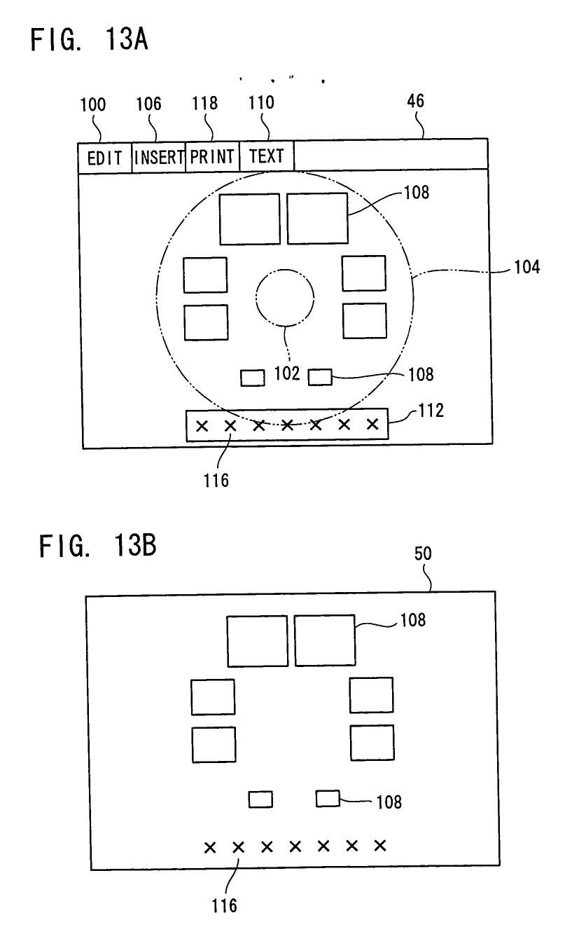

When the entry of characters into the text entry frame 112 is completed as shown in FIG. 13A, character data 116 are registered in a character data file 92, and an initial address thereof is registered in the information table 90. The entered character data 116 are stored in the first video memory 50, and now displayed as character data 116 to be printed on the display monitor 46, as shown in FIG. 13B.

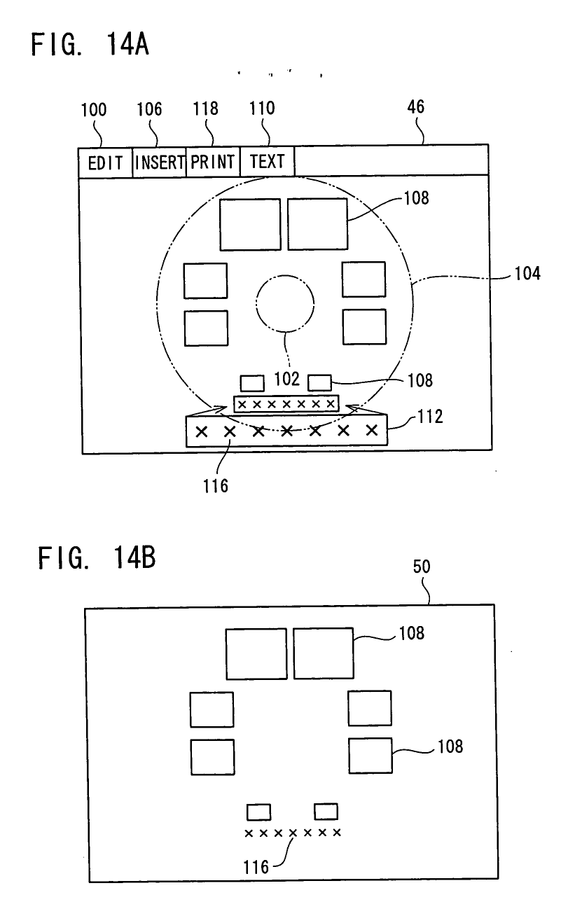

Thereafter, as shown in FIG. 14A, the user uses the input device 88, e.g., drags the mouse, to change the displayed positions of the character data 116, and enlarge and reduce the character data 116 so that the displayed character data 116 are brought into the printable surface 16 of the optical disk 12. When the displayed positions are changed and the character data are enlarged and reduced, coordinate data from the input device 88 are supplied to the character print instructing unit 86. Based on the supplied coordinate data, the character print instructing unit 86 calculates recording addresses at which the character data 116 are recorded in the first video memory 50 and a recording range of the character data 116, and registers the calculated recording addresses and the calculated recording range in the information table 90, i.e., rewrites the existing recording addresses and the existing recording range in the information table 90, as shown in FIG. 14B.

The user may enter character data 116 only once or a plurality of times. If the user enters character data 116 twice or more, then information about each of the character data 116 is registered in the information table 90 and stored in the first video memory 50.

When the editing of the image data 108 and the character data 116 to be printed is finished, the user selects a switch or icon 118 representing printing which is displayed on the display monitor 46.

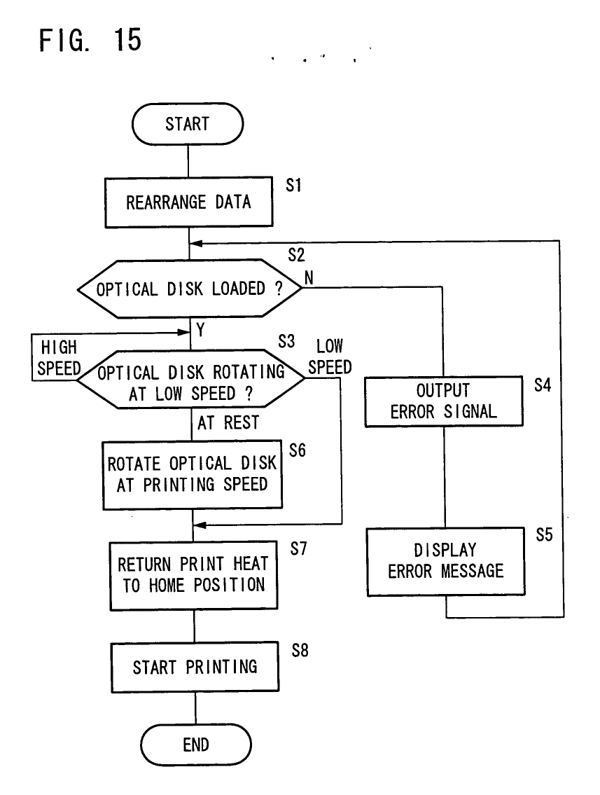

The printer 18 now starts to print the image data and the character data on the optical disk 12. A processing sequence of the printer 18, i.e., a printing process carried out by the printer 18, will be described below with reference to FIGS. 1 and 15.

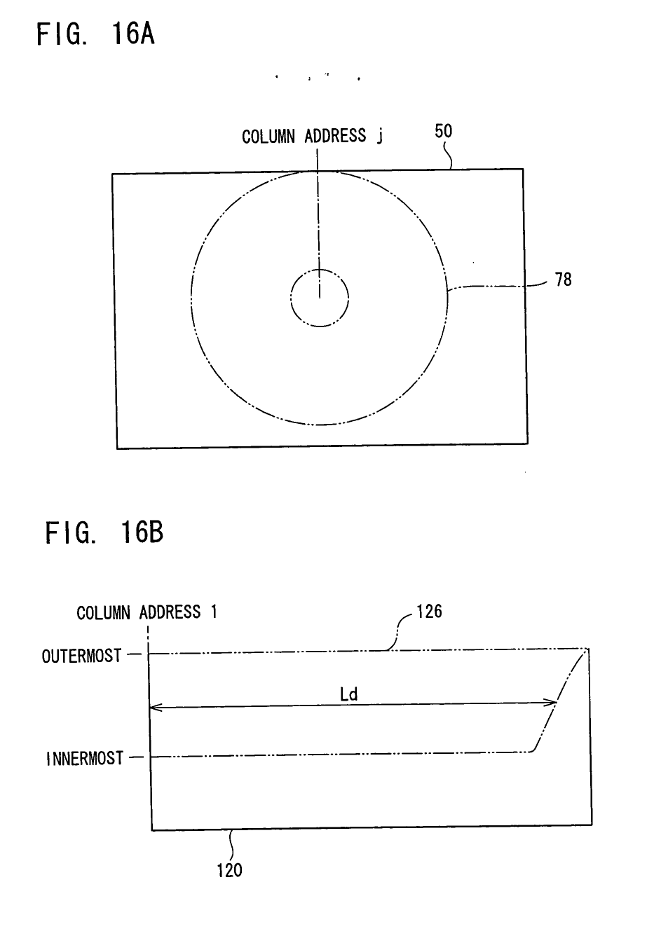

The second controller 64 controls the third memory controller 52 to extract data recorded in the recording area 78 of the first video memory 50, and also controls the memory converter 122 to rearrange the extracted data from the third memory controller 52 and store the rearranged data in the second video memory 120 in step S1 shown in FIG. 15. For example, as shown in FIG. 16A, the memory converter 122 converts the doughnut-shaped recording area 78 of the first video memory 50 into a strip-shaped recording area 126 of the second video memory 120 (see FIG. 16B), and records the data in the strip-shaped recording area 126 of the second video memory 120. According to one converting process, a column address (column address j) passing through the center of the doughnut-shaped recording area 78 is extracted, and the column address j is rearranged into an initial column address (column address 1) in the second video memory 120, as shown in FIG. 16B.

In step S2, the second controller 64 determines whether the optical disk 12 is loaded or not. If the optical disk 12 is loaded, then control goes to step S3. If the optical disk 12 is not loaded, then control goes to step S4 in which an error signal is output. Then, a message representing that no optical disk 12 is loaded is displayed on the display monitor 46 in step S5. Thereafter, the printing process may forcibly be put to an end, or control may wait until the optical disk 12 is loaded. In FIG. 15, control waits until the optical disk 12 is loaded.

In steps S7, S8, the print head 54 start to print data on the optical disk 12. If the print head 54 can print data on the optical disk 12 at the same time that the recorder and reproducer 14 records information in the optical disk 12, then the information recording and reproducing apparatus 10 operates highly efficiently. When information is recorded in the optical disk 12, the optical disk 12 rotates at a speed up to about 10000 rpm. If an ink jet is ejected to the optical disk 12 that is rotating at such a high speed, then the ink tends to flow in a radial pattern, greatly reducing the quality of printed data.

The quality of printed data can be increased if the data are printed on the optical disk 12 rotating at a lower speed, e.g., a speed of about 1000 rpm., after the recording of desired information in the optical disk 12 is finished. Alternatively, the data may be printed during a period in which the optical disk 12 is rotating at a speed of about 1000 rpm., when desired information is recorded in the optical disk 12 or when recorded information is reproduced from the optical disk 12. According to these solutions, the information recording and reproducing apparatus 10 can operate highly efficiently, and the quality of printed data on the optical disk 12, the data being printed while the optical disk 12 is in rotation, is prevented from being lowered.

In step S3, the second controller 64 determines whether the rotational speed of the optical disk 12 is low or not based on the information of the rotational speed from the rotation driver 24 of the recorder and reproducer 14.

If the rotational speed of the optical disk 12 is not low, but the optical disk 12 is held at rest, then control goes to step S6 to control the rotational speed of the optical disk 12 at a printing speed. For example, the second controller 64 sends a command to the first controller 32 to rotate the optical disk 12 at the printing speed. Based on the command from the second controller 64, the first controller 32 controls the rotation driver 24 to rotate the optical disk 12 at the printing speed.

Thereafter, in step S7, the second controller 64 returns the print head 54 to a home position, i.e., the radially outermost position P1 of the printable surface 16 of the optical disk 12. In step S8, the second controller 64 controls the head moving mechanism 60 to move the print head 54 in the radial direction of the optical disk 12 and also controls the print head 54 to print the data on the optical disk 12.

The printing process is carried out as follows: If the print head 54 is in the radially outermost position P1 of the printable surface 16 of the optical disk 12, for example, the optical disk 12 makes one revolution, and the second video memory 120 supplies data corresponding to the radially outermost circumferential area of the optical disk 12 to the print head 54, which prints the supplied data on the radially outermost area of the optical disk 12. When the printing of the data is finished, an end-of-print flag is set in a register incorporated in the second controller 64. When the head moving mechanism 60 recognizes that the end-of-print flag has been set in the register, then the head moving mechanism 60 resets the end-of-print flag, and moves the print head 54 a predetermined pitch radially inwardly toward the center of the optical disk 12.

Thereafter, the optical disk 12 makes one revolution, and the second video memory 120 supplies data corresponding to the present position of the print head 54 to the print head 54, which prints the supplied data on the circumferential area of the optical disk 12 which corresponds to the present position of the print head 54. When the printing of the data is finished, the end-of-print flag is set in the register incorporated in the second controller 64. When the head moving mechanism 60 recognizes that the end-of-print flag has been set in the register, then the head moving mechanism 60 resets the end-of-print flag, and moves the print head 54 a predetermined pitch radially inwardly toward the center of the optical disk 12.

The above operation is successively repeated until the print head 54 reaches the radially innermost position P2 of the optical disk 12. When the printing of data on the radially innermost circumferential area of the optical disk 12 is finished, the printing of the data on the optical disk 12 is completed.

If it is judged that the rotational speed of the optical disk 12 is already low in step S3, then control jumps to step S7 for printing the data on the optical disk 12.

If it is judged that-the rotational speed of the optical disk 12 is high in step S3, then control waits until the optical disk 12 is brought to a stop or rotates at a low speed. If the optical disk 12 is brought to a stop or rotates at a low speed, then control jumps to step S7 for printing the data on the optical disk 12.

In the above printing process, as shown in FIG. 1, the fourth memory controller 124 is controlled by the second controller 64 to read data (including an initial value “0”, image data, and character data) successively from addresses corresponding to the successive positions of the print head 54 from the second video memory 120, and supply the data to the print head 54.

The fourth memory controller 124 reads the data from the second video memory 120 as follows: The second controller 64 sets a readout rate at which data to be supplied to the print head 54 can be printed on the optical disk 12 while the optical disk 12 is making one revolution, based on the length Ld of the data to be supplied to the print head 54 at the present position that is detected based on the positional information from the encoder 72, and also based on the information of the rotational speed from the rotation driver 24. The second controller 64 then gives the readout rate to the fourth memory controller 124. The fourth memory controller 124 reads data from the address depending on the position of the print head 54 in the second video memory 120 according to the readout rate supplied from the second controller 64, and supplies the read data to the print head 54. If the data supplied to the print head 54 represents the initial value, then the print head 54 makes no printing. If the data supplied to the print head 54 represents image data and/or character data, then the print head 54 ejects an ink jet depending on the image data and/or the character data.

In this manner, the image data 108 and the character data 116 which have been edited by the user are printed on the printable surface 16 of the optical disk 12.

As described above, the information recording and reproducing apparatus 10 according to the embodiment of the present invention is capable of easily and accurately printing data (image data, character data, etc.) with respect to the information recorded in the optical disk 12 while the optical disk 12 is being loaded in the information recording and reproducing apparatus 10, without contaminating surrounding areas. Therefore, the information recording and reproducing apparatus 10 facilitates the recording by general users of information in the optical disk 12.

Although a certain preferred embodiment of the present invention has been shown and described in detail, it should be understood that various changes and modifications may be made therein without departing from the scope of the appended claims.

What is claimed is:

1. An apparatus for recording and reproducing information, comprising:
a recorder and reproducer for recording information in and/or reproducing information from an optical information recording medium mounted on a rotation driver; and
a printer for printing print information including image and character data on a printable surface of said optical information recording medium which is being mounted on said rotation driver;
wherein said printer comprises:
a print head disposed in confronting relation to said printable surface of said optical information recording medium which is being mounted on said rotation driver;
a moving mechanism for moving said print head radially of said optical information recording medium along a plane substantially parallel to said printable surface of said optical information recording medium;
storage means for temporarily storing said print information; and
a controller for controlling a readout rate at which said print information is to be read from said storage means based on at least rotational speed information from said rotation driver and positional information of said print head.

2. An apparatus according to claim 1, wherein said recorder and reproducer comprises:
a recording head disposed in confronting relation to a surface of said optical information recording medium which is opposite to said printable surface, for recording information in said optical information recording medium; and
a recording head moving mechanism for moving said recording head radially of said optical information recording medium.

3. An apparatus according to claim 1, wherein said print head has a nozzle region including a plurality of nozzles, said nozzle region having a longer side inclined to a moving direction of said print head by an angle of up to 45°.

4. An apparatus according to claim 1, wherein when said optical information recording medium is held at rest, said controller controls said rotation driver to rotate said optical information recording medium at a rotational speed suitable for printing said print information therein, and said print head prints said print information on said optical information recording medium while said optical information recording medium is rotating at said rotational speed.

5. An apparatus according to claim 1, wherein when said recorder and reproducer records information in and/or reproduces information from said optical information recording medium, said controller controls said print head to print said print information on said optical information recording medium while said optical information recording medium is rotating at a rotational speed suitable for printing said print information therein.

6. An apparatus according to claim 1, further comprising:
a print editor for editing said print information;
wherein said print editor supplies information with respect to either information to be recorded in said optical information recording medium or information recorded in said optical information recording medium as said print information to said printer.

7. An apparatus according to claim 6, wherein said print editor comprises:
means for employing part of either the information to be recorded in said optical information recording medium or the information recorded in said optical information recording medium as said print information.

8. An apparatus according to claim 6, wherein said print editor comprises:
means for acquiring the information with respect to either the information to be recorded in said optical information recording medium or the information recorded in said optical information recording medium through a network and employing the acquired information as said print information.

9. An apparatus according to claim 6, wherein said print editor comprises:
means for employing character information entered through an input device with respect to either the information to be recorded in said optical information recording medium or the information recorded in said optical information recording medium as said print information.

10. A method of printing information in an apparatus for recording information in and/or reproducing information from an optical information recording medium mounted on a rotation driver, for printing print information including image and character data on a printable surface of said optical information recording medium which is being mounted on said rotation driver, said method comprising the steps of:
temporarily holding said print information in a storage means;
placing a print head in confronting relation to said printable surface of said optical information recording medium which is being mounted on said rotation driver;
moving said print head radially of said optical information recording medium along a plane substantially parallel to said printable surface of said optical information recording medium;
printing said print information on said printable surface of said optical information recording medium while controlling a readout rate at which said print information is to be read from said storage means based on at least rotational speed information from said rotation driver and positional information of said print head.

11. A method according to claim 10, wherein said print head has a nozzle region including a plurality of nozzles, said nozzle region having a longer side inclined to a moving direction of said print head by an angle of up to 45°.

12. A method according to claim 10, wherein when said optical information recording medium is held at rest, said rotation driver is controlled to rotate said optical information recording medium at a rotational speed suitable for printing said print information thereon, and said print information is printed on said optical information recording medium while said optical information recording medium is rotating at said rotational speed.

13. A method according to claim 10, wherein when information is recorded in and/or reproduced from said optical information recording medium by, said print head is controlled to print said print information on said optical information recording medium while said optical information recording medium is rotating at a rotational speed suitable for printing said print information thereon.

14. A method according to claim 10, wherein information with respect to either information to be recorded in said optical information recording medium or information recorded in said optical information recording medium is printed as said print information on said printable surface of said optical information recording medium.

15. A method according to claim 14, wherein part of either the information to be recorded in said optical information recording medium or the information recorded in said optical information recording medium is printed as said print information on said printable surface of said optical information recording medium.

16. A method according to claim 14, wherein the information to be recorded in said optical information recording medium or the information recorded in said optical information recording medium is acquired through a network and printed as said print information on said printable surface of said optical information recording medium.

17. A method according to claim 14, wherein character information entered through an input device with respect to the information to be recorded in said optical information recording medium or the information recorded in said optical information recording medium is printed as said print information on said printable surface of said optical information recording medium.

18. An optical information recording medium having information recorded therein and print information printed thereon by a method according to claim 10.
